(19) United States
(12) Patent Application Publication
(10) Pub. No.: US 2017/0106719 A1
(43) Pub. Date: Apr. 20, 2017

(54) TUB-LESS REAR HVAC

(71) Applicant: Hanon Systems, Daejeon (KR)

(72) Inventors: Chad Engberg, Dearborn, MI (US); Hussein Awkal, Macomb, MI (US)

(21) Appl. No.: 15/206,855

(22) Filed: Jul. 11, 2016

Related U.S. Application Data
(60) Provisional application No. 62/243,449, filed on Oct. 19, 2015.

(51) Int. Cl. B60H 1/00; B60H 1/32; F25B 39/00

(52) U.S. Cl. CPC B60H 1/00514; F25B 39/00; B60H 1/3202; F25B 39/02

(57) ABSTRACT

A housing for an air-handling system includes a first housing shell and a second housing shell. The first housing shell includes a first casing portion and a tub portion monolithically formed. The tub portion is formed at a bottom of the main housing and includes a floor and a third sidewall. The second housing shell includes a casing portion configured to cooperate with the first casing portion to enclose a source air flow conduit of the main housing. The first housing shell further includes a first engaging feature circumscribing the first casing portion and the tub portion, and the second housing shell further includes a second engaging feature circumscribing the second casing portion. The first engaging feature is configured to cooperate with the second engaging feature to align the first housing shell and the second housing shell.

### CROSS-REFERENCES TO RELATED APPLICATION

This application claims priority to U.S. Provisional Patent Application No. 62/243,449, filed on Oct. 19, 2015, the disclosure of which is incorporated herein by reference in its entirety.

### FIELD OF THE INVENTION

The invention relates to a climate control system for a vehicle and more particularly to a climate control system for a heating, ventilating, and air-conditioning system for the vehicle.

### BACKGROUND

A vehicle typically includes a climate control system which maintains a temperature within a passenger compartment of the vehicle at a comfortable level by providing heating, cooling, and ventilation. Comfort is maintained in the passenger compartment by an integrated mechanism referred to in the art as a heating, ventilation and air-conditioning (HVAC) air-handling system. The air-handling system conditions air flowing therethrough and distributes the conditioned air throughout the passenger compartment.

Air-handling systems commonly include a main housing enclosing a source air flow conduit. The main housing may include various subcomponents of the air-handling system therein. Particularly, it is common for the main housing to include an evaporator for cooling a flow of air through the source air flow conduit. As a relatively warm air flows over a relatively cold surface of the evaporator, water vapor within the air condenses on the surface of the evaporator, and drains to a bottom of the housing.

Housings in conventional air-handling systems are formed of two opposing halves, coupled along a central seam. Although a compartmentalized configuration allows for easy assembly of the opposing halves, the central seam results in an unfavorable leak path along the bottom of the housing. The leak path may result in water leaking into the passenger compartment of the vehicle.

To prevent the leaking, the housings of the prior art are provided with a catch pan or a tub to capture condensate as the condensate leaks through the opposing halves of the housing. Although effective, use of a separate tub is undesirable, as the separate tub requires manufacture and assembly of an additional component for the air-handling system, thereby increasing complexity and cost.

Accordingly, there exists a need in the art for a simplified housing for an air-handling system capable of capturing and removing water from the air-handling system.

### SUMMARY OF THE INVENTION

Concordant and consistent with the present invention, a simplified housing for an air-handling system capable of capturing and removing water from the air-handling system has surprisingly been discovered.

A housing for an air-handling system includes a first housing shell and a second housing shell. The first housing shell includes a first casing portion and a tub portion monolithically formed. The tub portion is formed at a bottom of the first casing portion and includes a floor and a third sidewall. The second housing shell includes a casing portion configured to cooperate with the first casing portion to enclose a source air flow conduit of the main housing. The first housing shell further includes a first engaging feature circumscribing the first casing portion and the tub portion, and the second housing shell further includes a second engaging feature circumscribing the second casing portion. The first engaging feature is configured to cooperate with the second engaging feature to align the first housing shell and the second housing shell.

In another embodiment, an air-handling system for a heating, ventilation, and air-conditioning system includes a first housing shell including a first casing portion and a second casing portion. The air-handling system further includes a second housing shell including a second casing portion configured to cooperate with the first casing portion of the first housing shell to enclose a source air flow conduit. The air-handling system further includes an evaporator core, a heater core, and at least one door disposed therein. The first housing shell includes a cutout formed in the first casing portion thereof and an evaporator pocket formed in the tub portion thereof, the cutout and the evaporator pocket configured to receive opposing portions of the evaporator core therein.

In yet another embodiment, a method of assembling an air-handling system includes providing a first housing shell having a first casing portion and a tub portion. The first housing shell includes a first engaging feature circumscribing the first casing portion and the tub portion. A second housing shell having a second casing portion is provided, wherein the second housing shell has a second engaging feature circumscribing the second housing shell. The first engaging feature is inserted into the second engaging feature to assemble the first housing shell to the second housing shell.

### BRIEF DESCRIPTION OF THE DRAWINGS

FIG. 1 is a top front perspective view of an air-handling system according to an embodiment of the instant disclosure;

FIG. 2 is a cross-sectional view of a housing of the air-handling system of FIG. 1, taken along section line 2-2 as shown in FIG. 1.

FIG. 3 is an enlarged fragmentary cross-sectional view of the housing of FIG. 2, taken at area 3 of FIG. 2.

FIG. 4 is an enlarged fragmentary cross-sectional view of the housing of FIG. 2, taken at area 4 of FIG. 2.

FIG. 5 is a cross-sectional view of a housing of the air handling system of FIG. 1, taken along section line 5-5 as shown in FIG. 1.

FIG. 6 an enlarged fragmentary cross-sectional view of the housing of FIG. 5, taken at area 6 of FIG. 5.

FIG. 7 an enlarged fragmentary cross-sectional view of the housing of FIG. 5, taken at area 7 of FIG. 5.

FIG. 8 is an exploded perspective view of a housing of the air-handling system of FIG. 1; and

FIG. 9 is a top front perspective view of the air-handling system of FIG. 1, showing an interior of the air-handling system;

FIG. 10 is a top front perspective view of a first housing shell of the air-handling system of FIG. 1; and

FIG. 11 is a top rear perspective view of a second housing shell of the air-handling system of FIG. 1.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

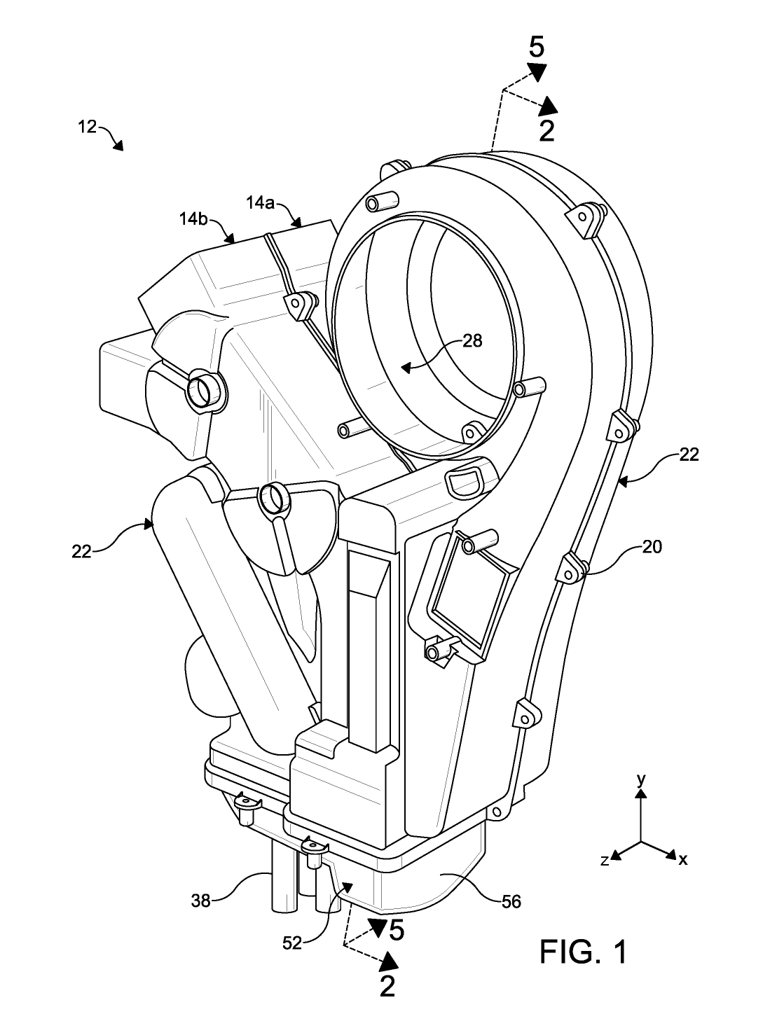

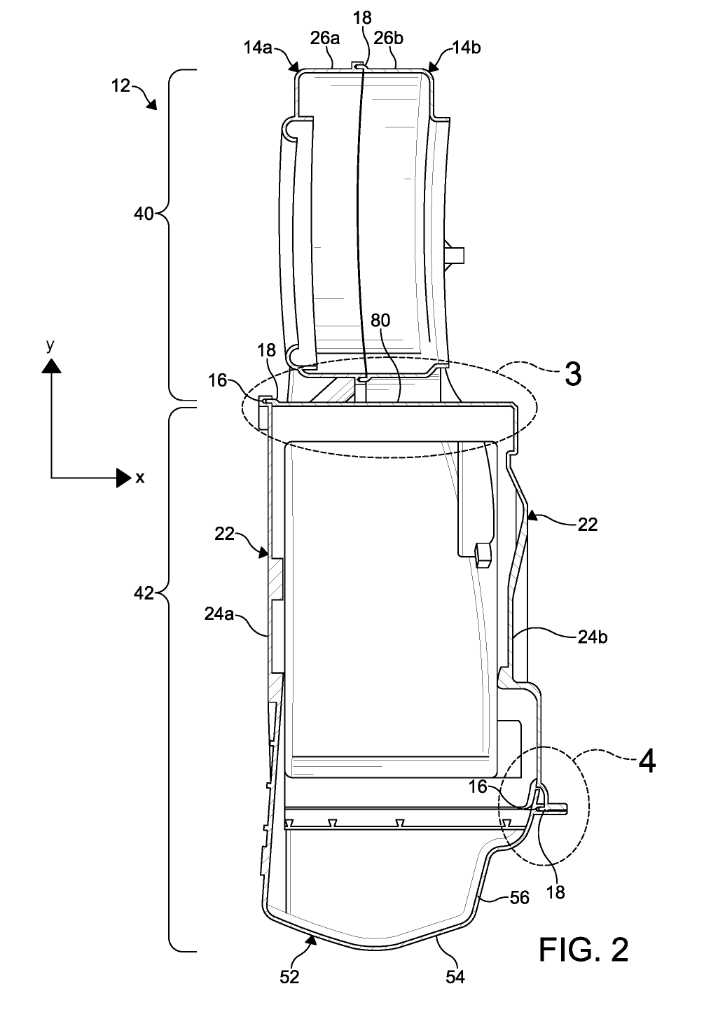

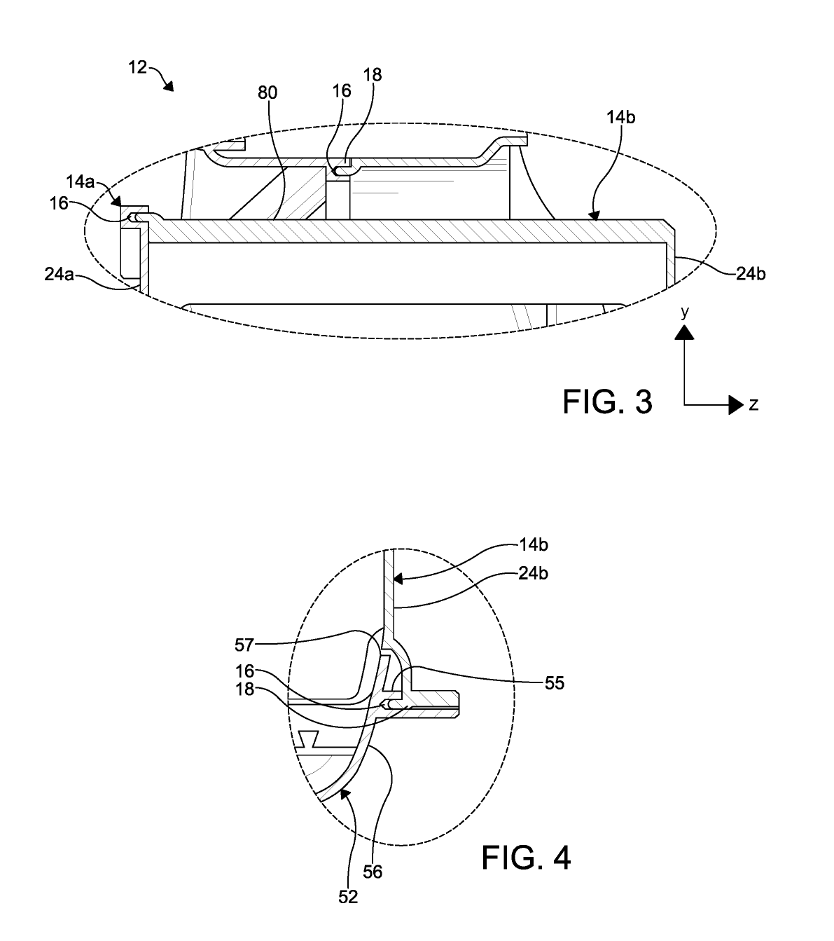

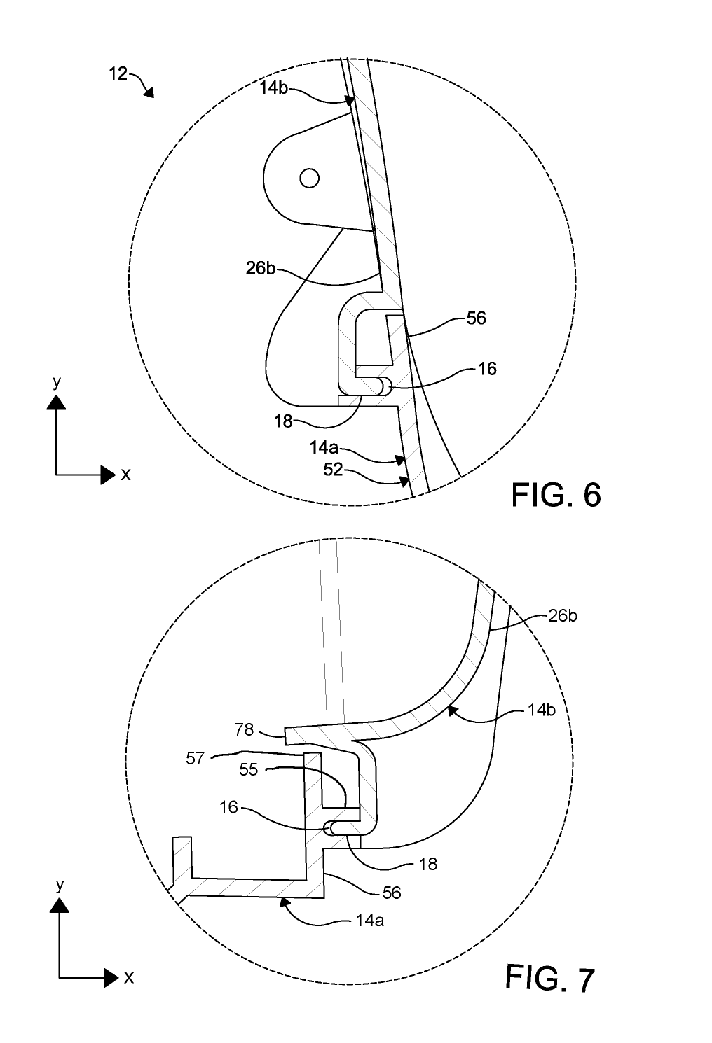

Referring now to FIGS. 1-11, an air-handling system 10 of a heating, ventilating, and air-conditioning (HVAC) system for a vehicle (not shown) according to an embodiment of the disclosure is shown. As used herein, the term “air” can refer to fluid in a gaseous state, fluid in a liquid state, or any combination thereof. The air-handling system 10 typically provides heating, ventilation, and air conditioning for a passenger compartment (not shown) of the vehicle. The air-handling system 10 is configured to be installed between an engine fire wall (not shown) and an interior trim panel (not shown) of the passenger compartment. It is understood that the air-handling system 10 may be installed in other locations of the vehicle as desired, such an instrument panel, trunk, console, floor, or engine compartment, for example.

The air-handling system 10 includes a hollow main housing 12 formed by a first housing shell 14a and a second housing shell 14b. In the embodiment shown, the housing shells 14a, 14b are formed of a plastic material and are configured to interface with each other. It is understood that the housing shells 14a, 14b may be formed from other materials as desired, such as a metal or composite, for example.

The first housing shell 14a and the second housing shell 14b are configured to slidingly engage each other, wherein a first engaging feature 16 of the first housing shell 14a cooperates with a corresponding second engaging feature 18 of the second housing shell 14b to maintain relative alignment between the housing shells 14a, 14b. In the illustrated embodiment, the first engaging feature 16 of the first housing shell 14a receives the second engaging feature 18 of the second housing shell 14b to maintain the relative alignment. Particularly, the first engaging feature 16 of the first housing shell 14a may be a groove formed about a perimeter thereof, and the second engaging feature 18 of the second housing shell 14b is a tongue formed about a perimeter thereof, wherein the first engaging feature 16 is configured to receive the second engaging feature 18 to sealingly enclose the housing 12. Although the illustrated embodiment shows the first engaging feature 16 being the groove and the second engaging feature 18 being the tongue, it will be appreciated by those of ordinary skill in the art that the first engaging feature 16 may be the tongue and the second engaging feature may be the groove. The first housing shell 14a and the second housing shell 14b may further include a plurality of mounting tabs 20 configured to cooperate to align and fasten the first housing shell 14a to the second housing shell 14b.

In the illustrated embodiment, an entirety of the groove forming the first engaging feature 16 opens in a first direction of the housing 12, and the corresponding tongue forming the second engaging feature 18 extends along the same first direction from the second housing shell 14b of the housing 12, wherein the second engaging feature 18 can be slidingly received into the first engaging feature 16 by converging the first housing shell 14a and the second housing shell 14b along the first direction. For illustrative purposes, the first direction of the housing 12 will be understood to be the direction of a width of the housing, along the z-axis, as defined in FIG. 1. However, in alternate embodiments, the first direction may be any direction, wherein an entirety of the first engaging feature 16 can be slidingly engaged with an entirety of the second engaging feature 18.

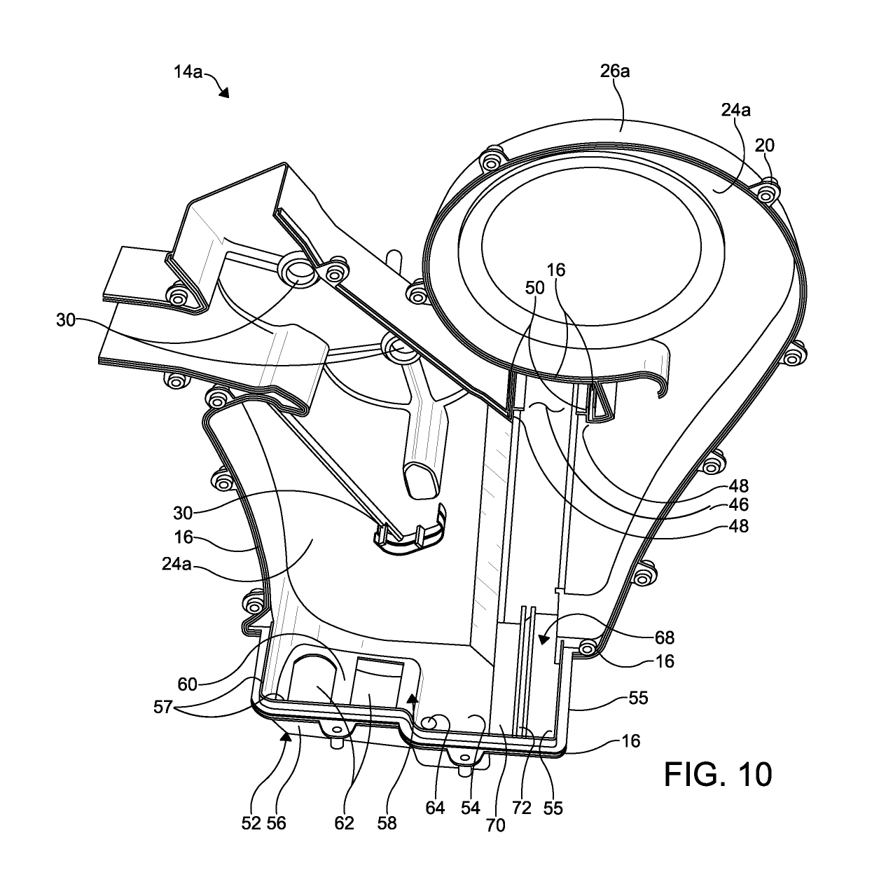

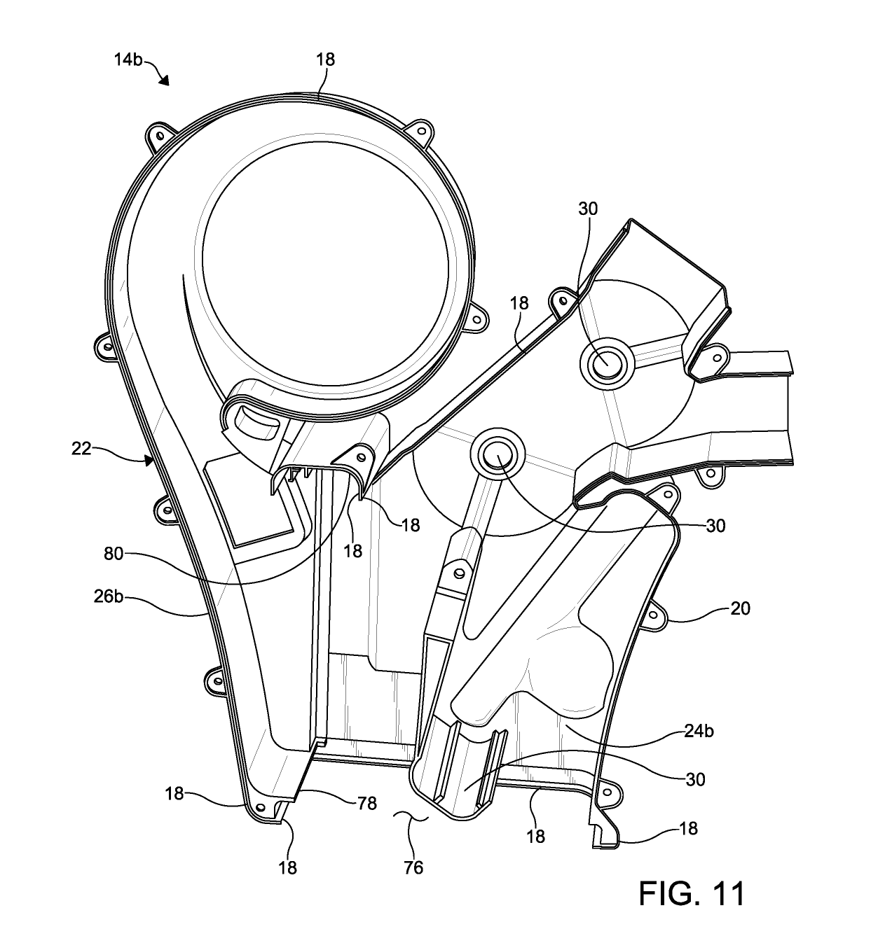

Each of the first housing shell 14a and the second housing shell 14b includes a casing portion 22. The casing portion 22 is formed of a substantially planar first sidewall 24a, 24b and a second sidewall 26a, 26b. The second sidewall 26a, 26b extends laterally from a perimeter of the first sidewall 24a, 24b at a non-opposite and non-identical angle, wherein the second sidewall 26a of the first housing shell 14a and the second sidewall 26b of the second housing shell 14b cooperate with each other to define a source air flow conduit 28 when the first housing shell 14a is assembled to the second housing shell 14b. In the illustrated embodiment, the second sidewall 26a, 26b extends substantially orthogonally from the first sidewall 24a, 24b, wherein the first sidewall lies substantially in the x-y plane, and the second sidewall extends in the first direction therefrom, as shown in FIGS. 10 and 11.

As shown in FIGS. 10 and 11, the first engaging feature 16 is formed along an entirety of a distal end of the second sidewall 26a of the first housing shell 14a, and the second engaging feature 18 is formed along an entirety of a distal end of the second sidewall 26b of the second housing shell 14b, wherein an entirety of the first engaging feature 16 of the second sidewall 26a of the first housing shell 14a receives an entirety of the second engaging feature 18 of the second sidewall 26b of the second housing shell 14b.

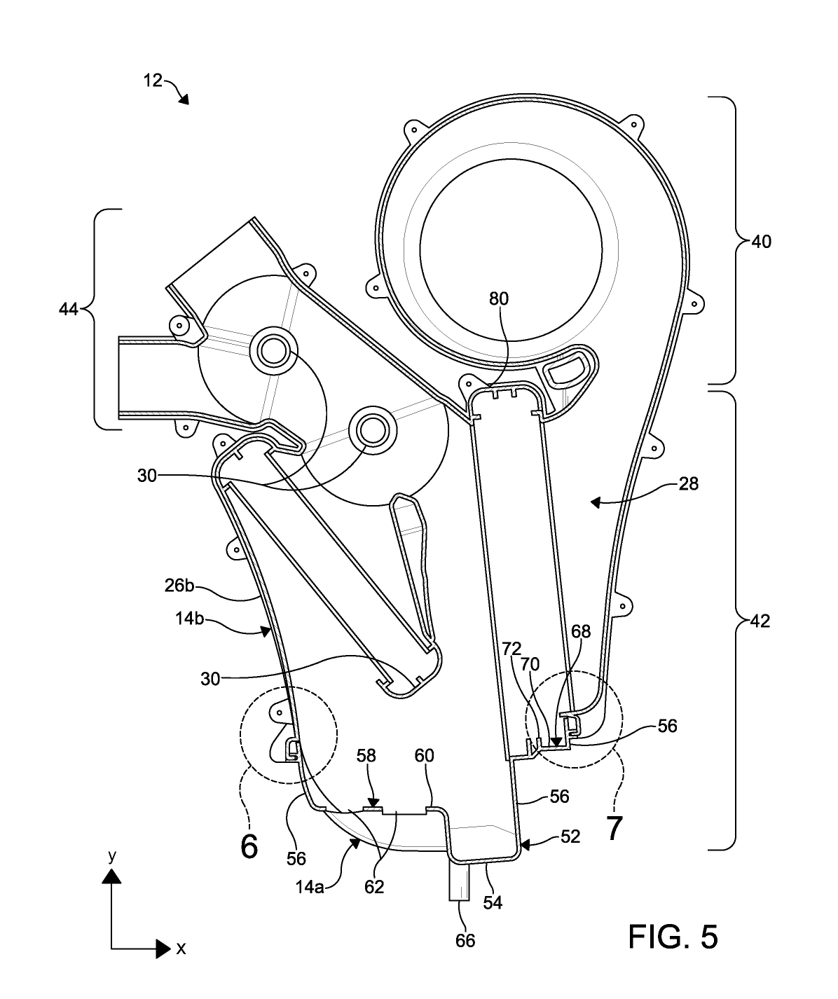

Referring to FIGS. 5, 8, 10, and 11, the casing portion 22 of each of the first housing shell 14a and the second housing shell 14b further includes a plurality of mounting features 30 configured to facilitate installation of subcomponents of the air-handling system 10, such as doors 32, a heater core 34, an evaporator core 36, and conduits 38, for example.

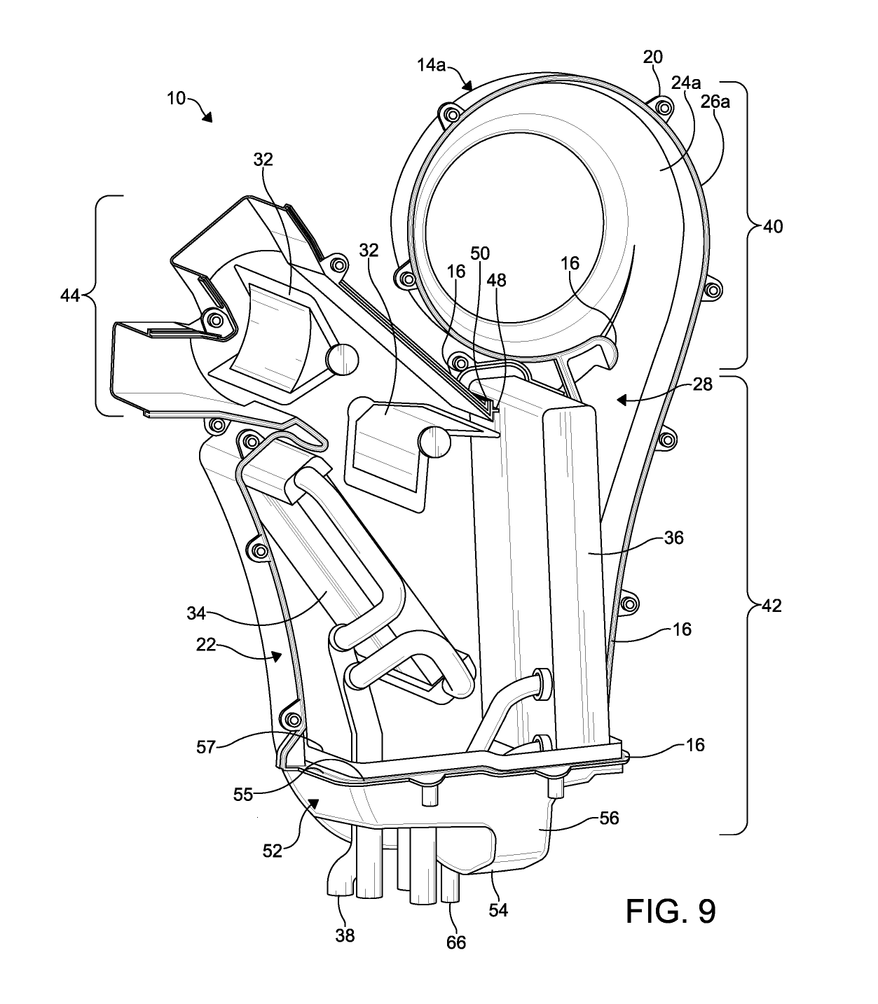

The source air flow conduit 28 includes an inlet section 40 in fluid communication with a supply of air, a mixing section 42 configured to condition the air flow, and a delivery section 44 configured to distribute the air flow to a passenger compartment of a vehicle. If desired, a filter (not shown) may be provided upstream or downstream of the inlet section 40. The supply of air can be provided from outside of the vehicle, recirculated from the passenger compartment of the vehicle, or a mixture of the two, for example. The mixing section may receive 42 the evaporator core 36, the heater core 34, and at least one of the doors 32, as shown in FIG. 9. The evaporator core 36 and the heater core 34 are in communication with a source of cooled fluid (not shown) and a source of heated fluid (not shown) through the conduits 38, respectively.

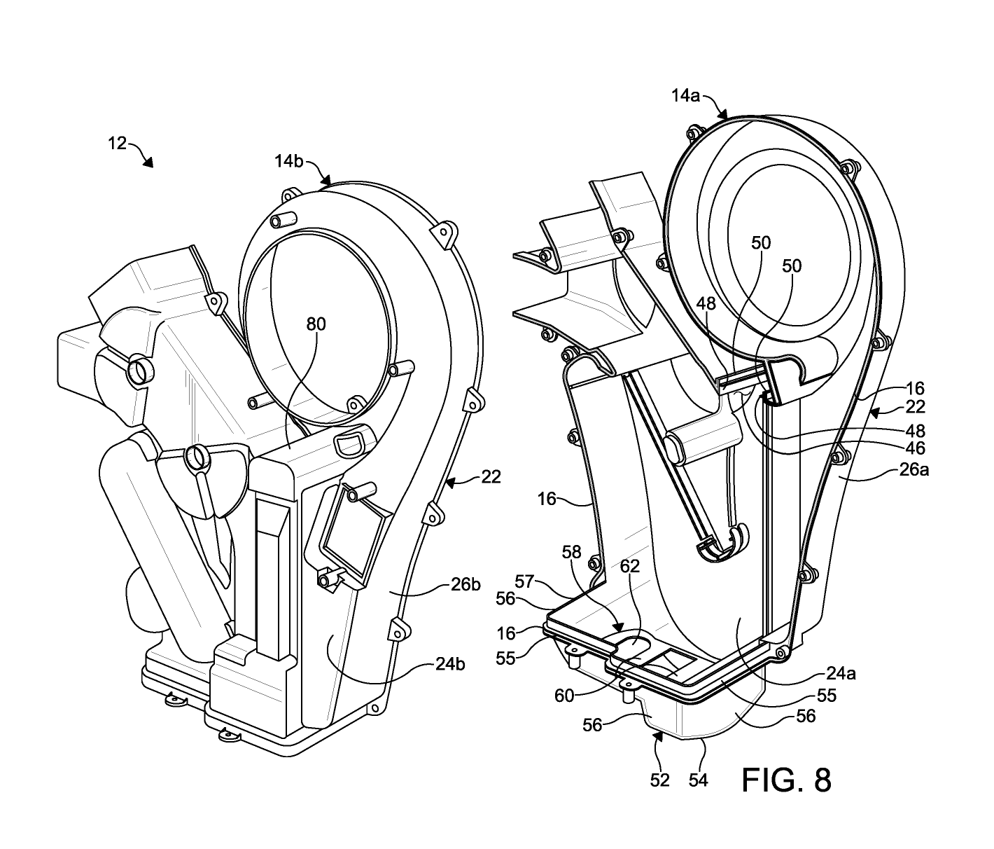

As shown in FIGS. 8 and 10, the second sidewall 26a of the first housing shell 14a includes a cutout 46 formed therein. The cutout 46 is configured to receive a portion of the evaporator core 36 therethrough when the air handling system 10 is assembled. The cutout 46 is formed intermediate opposing ends 48 of the second sidewall 26a. Each of the ends 48 may include a portion of the first engaging feature 16 formed therein for receiving a corresponding portion of the second engaging feature 18 of the second housing shell 14b. In the illustrated embodiment, a lip 50 extends outwardly from the sidewall 26a of the first housing shell 14a, and includes a portion of the first engaging feature 16 formed therein. However, it will be appreciated that the lip 50 may extend inwardly from the sidewall 26a in other embodiments. In yet another embodiment, the cutout 46 may not include the lip 50, and the portion of the first engaging feature 16 may be formed directly in the ends 48 of the second sidewall 26a. A portion of the first engaging feature 16 formed on the first sidewall 24 of the first housing shell 14a spans the cutout, and is configured to receive a portion of the second housing shell 14b therein.

The first housing shell 14a further includes a tub portion 52 formed integrally or monolithically with the casing portion 22, as shown in FIGS. 1, 2, 5, 8, and 9-10. More particularly, the tub portion 52 is integrally formed with and extends beyond the second sidewall 26a of the first housing shell 14a. The tub portion 52 is formed at a bottom of the first housing shell 14a and includes a floor 54 and a plurality of sidewalls 56 extending upward from and circumscribing a perimeter of the floor 54.

In the illustrated embodiment, the floor 54 and the sidewalls 56 are continuously formed with the second sidewall 26a, wherein the tub 52 is merely an extended portion of the second sidewall 26a. A portion of the first engaging feature 16 of the first housing shell 14a is disposed on the sidewalls 56 and circumscribes the tub 52. In the illustrated embodiment, the portion of the first engaging feature 16 formed in the tub 52 is continuously formed with the portion of the first engaging feature 16 formed in the second sidewall 26a of the first housing shell 14a. As shown, the first engaging feature 16 of the tub 52 is formed in a lip 55 that protrudes laterally outwardly from the third sidewalls 56. However, in other embodiments, the first engaging feature 16 may be formed as a recess in the sidewalls 56 of the tub 52. The first engaging feature 16 of the tub 52 is vertically spaced below a terminal upper edge 57 of the sidewalls 56, wherein a portion of each the sidewalls 56 extends above the first engaging feature 16.

The tub portion 52 includes a raised boss 58 extending upward from the floor 54. An upper boss surface 60 of the boss 58 includes at least one aperture 62 configured to receive conduits 38 therethrough. As shown, the upper boss surface 60 includes a first aperture 62 for receiving conduits 38 communicating with the evaporator core 36, and a second aperture 62 for receiving conduits 38 communicating with the heater core 34. The upper boss surface 60 is spaced below the upper terminal edge 57 of the sidewall 56. Forming the upper boss surface 60 above the floor 54 and below the terminal upper edge 57 advantageously prevents condensate which may collect in the tub 52 from escaping the tub 52 through the apertures 62.

The floor 54 of the tub portion 52 includes a water drain 64 formed therein. The drain 64 is formed in a lowest portion of the floor 54 to maximize removal of condensate from the tub portion 52 during operation of the HVAC system. As shown, the drain 64 is an aperture formed in the floor 54, and is in fluid communication with a nipple 66 formed on a bottom exterior surface of the floor 54. In alternate embodiments, the drain may be formed in one of the sidewalls 56 of the tub portion 52.

The tub portion 52 further includes an evaporator pocket 68 formed therein. The evaporator pocket 68 includes an upper support surface 70 configured to receive and support a portion of the evaporator core 36 when the air-handling unit is assembled. The upper support surface 70 is disposed below the upper terminal edge of the sidewalls 56 to facilitate capture and removal of water condensate that may drip from the evaporator core 36. The upper support surface 70 may include at least one support rib 72 configured to engage a portion of the evaporator core 36. The support rib 72 provides a space between the upper support surface 70 and the evaporator core 36 to facilitate efficient removal of water condensate from a surface of the evaporator core 36.

Referring now to FIG. 11, the second housing shell 14b includes an opening 76 formed in a bottom portion thereof. The opening 76 is defined on three sides by the first sidewall 24b and opposing terminal ends of the second sidewall 26b of the second housing shell 14b. The second engaging feature 18 of the second housing shell 14b circumscribes the opening 76, and is disposed adjacent the terminal ends of the second sidewall 26b and the first sidewall 24b. In alternate embodiments, the portion of the second engaging feature 18 formed in the opening 76 may be spaced from the terminal ends of the sidewalls 24b, 26b. The second housing shell 14b may further include an interior flange 78 disposed adjacent the opening 76, and extending laterally inwardly from the sidewalls 24b, 26b. The flange 78 is configured to align with or overhang the sidewalls 56 of the tub portion 52 when the second housing shell 14b is assembled to the first housing shell 14a, wherein condensate collected on the sidewalls 24b, 26b of the second housing shell 14b is guided in to the tub portion 52 by the flange 78.

As shown in FIGS. 1, 2, 3, 5, 7, and 11, the second housing shell 14b has a cover portion 80 extending from the second sidewall 26b in the first direction. The cover portion 80 is positioned opposite the evaporator pocket 68 of the tub portion 52, and is configured to enclose the cutout 46 of the first housing shell 14a when the housing 12 is assembled. In the illustrated embodiment, a portion of the second engaging feature 18 extends along opposing terminal edges 82 of the cover portion 80, and is configured to be received in the portions of the first engaging feature 16 formed in the edges 48 of the second sidewall 26a defining the cutout 46. A distal end of the cover portion 80 is configured to be received in the portion of the first engaging feature 16 formed on the first sidewall 24a, wherein the portion of the first engaging feature 16 formed on the first sidewall spans the cutout 46 of the first housing shell 14a. The cover portion 18 may be substantially arcuate or cup shaped in cross-section, wherein a portion of the evaporator core 36 is received therein when the air handling system 10 is assembled.

During assembly, the cutout 46 formed in the second sidewall 26a of the first housing shell facilitates installation of the evaporator core 36 in the tub portion 52. To clear the sidewalls 56 of the tub portion 52, the evaporator core 36 is lifted above the sidewalls 56. The evaporator core 36 is then inserted into the cutout 46 in the first direction until the evaporator core 36 abuts the first sidewall 24a of the first housing shell 14a. When the evaporator core 36 is contained within the sidewalls 56 of the tub portion 52, the evaporator core 36 is lowered onto the upper support surface 70 of the evaporator pocket 68, wherein the support rib 72 is partially received in a corresponding surface feature of the evaporator core 36.

After installation of the at least one door 32, the heater core 34, the evaporator core 36, and the conduits 38 of the air-handling assembly 10 onto the corresponding mounting features 30 of the first housing shell 14a, the second housing shell 14b is assembled to the first housing shell 14a to enclose the source air flow conduit 28 of the main housing 12. In the illustrated embodiment, the entirety of the second engaging feature 18 of the second housing shell 14b engages the entirety of the first engaging feature 16 of the first housing shell 14a by converging the first housing shell 14a and the second housing shell 14b along the first direction. An entirety of the opening of the second housing shell 14b is disposed above an interior of the third sidewall 56 of the tub portion 52 to facilitate drainage of condensate from the casing portion 22 to the tub portion 52. Portions of the subcomponents 32, 34, 36, 38 of the air-handling system 10 may be received in the mounting features 30 of the second housing shell 14b to secure the subcomponents in place.

Forming the tub portion 52 integrally with the casing portion 22 of the first housing shell 14a advantageously minimizes manufacturing costs of HVAC systems by eliminating the need for a separately formed tub. The monolithically formed first housing shell 14a can be formed in a single molding step and eliminates the need for assembly of the tub portion 52 to the air-handling system 10.

While certain representative embodiments and details have been shown for purposes of illustrating the invention, it will be apparent to those skilled in the art that various changes may be made without departing from the scope of the disclosure, which is further described in the following appended claims.

What is claimed is:

1. A housing for air-handling system comprising:
a first housing shell having a first casing portion and a tub portion formed at a bottom of the first casing portion; and
a second housing shell having a second casing portion, the second housing shell configured to cooperate with the first housing shell to define a source air flow conduit.

2. The housing of claim 1, wherein the first casing portion and the second casing portion each include a first sidewall and a second sidewall, the second sidewall extending from the first sidewall at a substantially perpendicular angle.

3. The housing of claim 1, wherein the first housing shell includes a first engaging feature circumscribing a perimeter of the first casing portion and the tub portion, and the second housing shell includes a second engaging feature circumscribing a perimeter of the second casing portion, wherein the first engaging feature is configured to cooperate with the second engaging feature to align the first housing shell and the second housing shell.

4. The housing of claim 3, wherein the tub portion further comprises a floor and a plurality of sidewalls monolithically formed with the casing portion.

5. The housing of claim 4, wherein a portion of the first engaging feature circumscribes the sidewalls of the tub portion and is continuously formed with the portion of the first engaging feature of the first casing portion.

6. The housing of claim 5, wherein the second housing shell includes an opening formed in a bottom portion thereof, the opening circumscribed by a portion of the second engaging feature.

7. The housing of claim 6, wherein the second housing shell includes an inwardly extending flange disposed adjacent the opening.

8. The housing of claim 7, wherein a first portion of the flange overhangs the sidewalls of the tub portion, and wherein a second portion of the flange is aligned with the sidewalls of the tub portion.

9. The housing of claim 1, wherein the first housing shell includes a cutout formed in the second sidewall of the first casing and an evaporator pocket formed in the tub portion, the evaporator pocket formed opposite the cutout.

10. The housing of claim 9, wherein the second housing shell includes a cover extending in a first direction beyond the second sidewall, the cover configured to be received in and enclose the cutout.

11. The housing of claim 1, wherein a floor of the tub portion includes a drain formed therein.

12. The housing of claim 11, wherein the tub portion includes a raised boss formed therein, the raised boss including an upper boss surface spaced above the floor, the upper boss surface having an aperture formed therein.

13. The housing of claim 3, wherein the first engaging feature is one of a groove and a tongue, and the second engaging feature is the other of a groove and a tongue, and wherein the groove receives the tongue.

14. The housing of claim 13, wherein the groove opens in a first direction with respect to the housing, and the tongue extends along the first direction, wherein the tongue is slidingly received in the groove along the first direction.

15. An air-handling system for a heating, ventilation, and air conditioning system comprising:
a first housing shell including a first casing portion and a tub portion monolithically formed; and
a second housing shell, the second housing shell including a second casing portion configured to cooperate with the first casing portion to enclose a source air flow conduit of the main housing.

16. The air-handling system of claim 15, wherein the tub portion is formed at a bottom of the first housing shell and includes a floor and a plurality of sidewalls.

17. The air-handling system of claim 15, further comprising an evaporator core, a heater core, and at least one door disposed therein.

18. The air-handling system of claim 17, wherein the first housing shell includes a cutout and an evaporator pocket formed therein, the cutout and the evaporator pocket configured to receive opposing portions of an evaporator core therein.

19. The air-handling system of claim 18, wherein the second housing shell includes a cover portion configured to enclose the cutout of the first housing shell.

20. A method of assembling an air-handling system comprising:
providing a first housing shell having a first casing portion and a tub portion, a first engaging feature circumscribing the first casing portion and the tub portion; and a second housing shell having a second casing portion, the second housing shell having a second engaging feature circumscribing the second housing shell;
inserting the first engaging feature into the second engaging feature in a first direction to assemble the first housing shell to the second housing shell.
